(19) United States
(12) Patent Application Publication
(10) Pub. No.: US 2024/0256755 A1
(43) Pub. Date: Aug. 1, 2024

(54) METHOD AND SYSTEM FOR VERIFYING INTEGRATED CIRCUIT

(71) Applicant: Samsung Electronics Co., Ltd., Suwon-si (KR)

(72) Inventors: Eunsun JUNG, Suwon-si (KR); Jeongmin KIM, Suwon-si (KR); Hoyoung LEE, Suwon-si (KR)

(73) Assignee: Samsung Electronics Co., Ltd., Suwon-si, Gyeonggi-do (KR)

(21) Appl. No.: 18/419,016

(22) Filed: Jan. 22, 2024

(30) Foreign Application Priority Data
Jan. 26, 2023 (KR) 10-2023-0010239

(51) Int. Cl. G06F 30/398

(52) U.S. Cl. CPC G06F 30/398

(57) ABSTRACT

A method of verifying an integrated circuit includes obtaining first data defining elements in the integrated circuit and second data defining positions and connection relationships of the elements, generating chip data by merging the first data and the second data in the background, performing a plurality of physical verifications in parallel, and generating output data, based on results of at least one of physical verifications. The performing of the plurality of physical verifications in parallel includes extracting verification input data used for physical verification, based on the chip data.

### CROSS-REFERENCE TO RELATED APPLICATION

This application is based on and claims priority under 35 U.S.C. § 119 to Korean Patent Application No. 10-2023-0010239, filed on Jan. 26, 2023, in the Korean Intellectual Property Office, the disclosure of which is incorporated by reference herein in its entirety.

### BACKGROUND

Various example embodiments to verification of an integrated circuit, and more particularly, to a method and system for verifying an integrated circuit.

As reduction or miniaturization of semiconductors progresses, the degree of integration of semiconductor designs may increase and semiconductor process geometries may be scaled down Accordingly, the need or desire for a physical verification environment may increase. In other words, it may be difficult to come up with a design that will enable production of a working product. Verification of the designed integrated circuit may be used or required to reduce defects occurring in the semiconductor before the designed semiconductor is actually put into a process and mass-produced. Verification of the circuit may include various physical verifications, and multiple verification operations may be used or required to derive a producible circuit.

### SUMMARY

Various example embodiments provide a method and/or system for verifying an integrated circuit that automatically performs at least one physical verification result on the integrated circuit to generate a verification result.

According to some example embodiments, there is provided a method of verifying an integrated circuit including obtaining first data defining elements in the integrated circuit, and second data defining positions and connection relationships of the elements, generating chip data by merging the first data and the second data in the background, performing a plurality of physical verifications in parallel, and generating output data, based on results of at least one of physical verifications. The performing of the plurality of physical verifications in parallel includes extracting verification input data required for physical verification, based on the chip data.

Alternatively or additionally according to various example embodiments, there is provided a system for verifying an integrated circuit, the system including at least one processor, and a non-transitory storage medium storing instructions which, when executed by the at least one processor, cause the at least one processor to execute a process of verifying the integrated circuit, wherein the at least one processor obtains first data defining elements in the integrated circuit, and second data defining positions and connection relationships of the elements, generates chip data by merging the first data and the second data in the background, performs at least one physical verification in parallel, and generates output data, based on results of the at least one physical verification, wherein the performing of at least one physical verification in parallel includes extracting verification input data required for physical verification from the chip data.

Alternatively or additionally according to various example embodiments, there is provided a non-transitory storage medium for storing instructions which, when executed by at least one processor, cause the at least one processor to execute a process of verifying an integrated circuit, wherein the process of verifying the integrated circuit includes obtaining first data defining elements in the integrated circuit, and second data defining positions and connection relationships of the elements, generating chip data by merging the first data and the second data in the background, performing at least one physical verification in parallel, and generating output data, based on results of the at least one physical verification, wherein the performing of at least one physical verification in parallel includes extracting verification input data required for physical verification from the chip data.

### BRIEF DESCRIPTION OF THE DRAWINGS

Various example embodiments will be more clearly understood from the following detailed description taken in conjunction with the accompanying drawings in which:

FIG. 1 is a block diagram illustrating a method of verifying an integrated circuit, according to various example embodiments;

FIG. 2 is a conceptual diagram illustrating a method of identifying and allocating at least one internal variable required for physical verification, according to various example embodiments;

FIG. 3 is a flowchart illustrating a method of verifying an integrated circuit, according to various example embodiments;

FIG. 4 is a flowchart illustrating a method of verifying an integrated circuit including a selection function, according to various example embodiments;

FIG. 5 is a flowchart illustrating a method of verifying an integrated circuit, including a process of identifying and allocating internal variables, according to various example embodiments;

FIG. 6 is a flowchart illustrating a method of verifying an integrated circuit, including a function of correcting a verification process by identifying editing rights, according to various example embodiments;

FIG. 7 is a block diagram illustrating a physical verification method of an integrated circuit, according to various example embodiments;

FIG. 8 is a block diagram illustrating a computer system according to an embodiment; and

FIG. 9 is a block diagram illustrating a system according to an embodiment.

### DETAILED DESCRIPTION OF VARIOUS EXAMPLE EMBODIMENTS

Hereinafter, embodiments of the inventive concept are described in detail with reference to the accompanying drawings. The same reference numerals are used for the same components in the drawings, and descriptions already given for them are omitted.

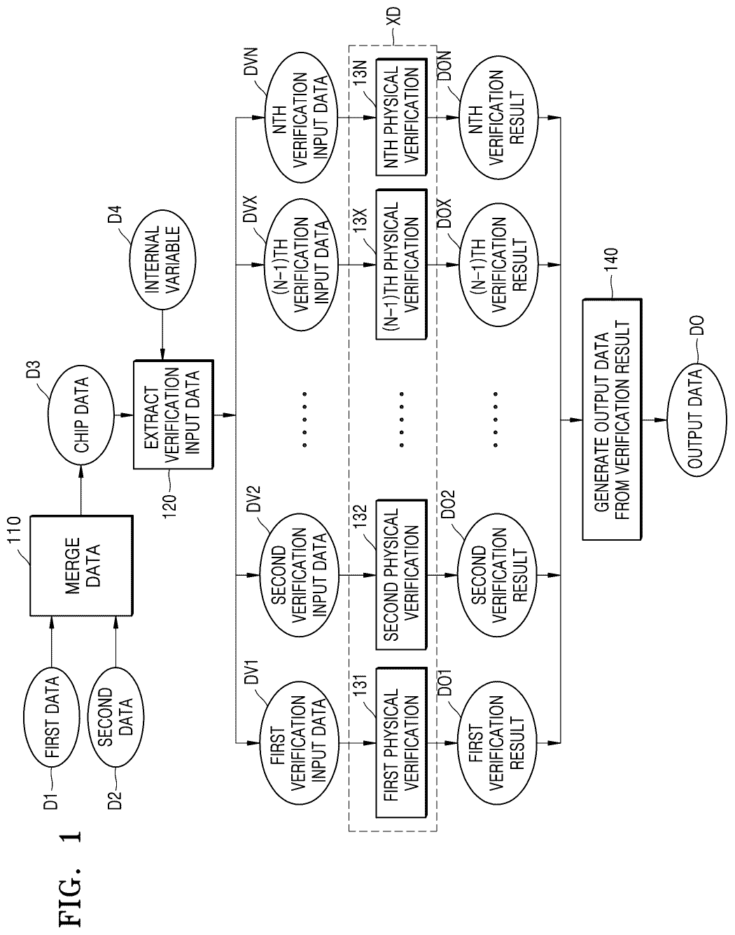

FIG. 1 is a block diagram illustrating a method of verifying an integrated circuit, according to various example embodiments.

Referring to FIG. 1, an integrated circuit verification system performing a verification method or a verification method of an integrated circuit may receive first data D1 and second data D2 of the integrated circuit to be verified, and may output output data DO based on verification results. Verification of the integrated circuit may include physical verification of the integrated circuit. The physical verification may be verification of whether a design capable of producing a product in normal operation may be derived after an integrated circuit is designed and before entering a process operation. Alternatively or additionally, the physical verification may be a procedure to check that an integrated circuit may be produced that may operate as designed. In some example embodiments, the integrated circuit verification system may be or include an integrated circuit designing system, wherein the system helps assist in the design of the integrated circuit.

The physical verification may include several types of verification. As an example, the physical verification may include one or more of design rule check (DRC), design for manufacturability (DFM), layout versus layout (LVL), layout versus schematic (LVS), Verilog to LVS (V2LVS), optical proximity check (OPC) verification, dummy-fill check verification, and/or the like.

The DRC verification may include verification of whether the integrated circuit is designed to satisfy various rules required or expected in the process of performing a process, for example, various design rules. As an example, the DRC verification may include design rules that a foundry company that performs a semiconductor process requires or expects from a fabless company that performs semiconductor design. The design rules in the DRC verification may include pattern shapes, sizes, intervals, spacings, pitches, feature sizes, etc., and the design rules may vary depending on the type of process or type of material.

The DFM verification may include verification of whether the design is made to ensure or help improve upon manufacturability. As the process of integrated circuits is miniaturized, additional conditions may be required or expected of the design of circuits to secure or help to secure manufacturability. As an example, the DFM verification may check whether layout conditions are met to ensure or help ensure consistency of metal wiring spacing in patterning. Alternatively or additionally, the DFM verification may check whether the conditions for area check, density gradient, etc. of the metal in the circuit are met. In order to secure or help secure manufacturability in the DFM verification, design conditions may be imposed in consideration of the influence of a product by a lithography process, a chemical mechanical polishing (CMP) process, and the like. For example, in some example embodiments critical areas of the design may be extracted and simulated for defectivity; example embodiments are not limited thereto.

The LVL verification may include verification of comparing two layouts of an integrated circuit to find a difference between the two layouts. The LVL verification may include comparison of components and geometries in two layouts. In addition, because there may be many repeated circuit patterns in an integrated circuit, the LVL verification may be performed for mutual comparison between layout patterns.

The LVS verification may include verifying whether the designed integrated circuit layout corresponds to the schematic of the integrated circuit. The LVS verification may verify whether shorts and/or opens of wires correspond properly. Alternatively or additionally, the LVS verification may check for component inconsistencies or missing components. As an example, the LVS verification may verify the position and connection structure of the transistor, and the connection state of the positive supply voltage (VDD) and the negative supply voltage (GND).

The V2LVS verification may include verification of whether the described Verilog program is well converted into a target circuit diagram. Verilog may refer to a hardware description language (HDL) used for electronic circuits. In addition, a circuit diagram may be described and designed in Verilog. Through the V2LVS verification, Verilog may be converted to the corresponding circuit diagram. In addition, a circuit diagram corresponding to Verilog, which is an output of V2LVS, may be input to the above-described LVS verification.

Referring to FIG. 1, the integrated circuit verification system according to various examples may perform at least one physical verification (XD) in parallel in a process of performing an integrated circuit verification method. The at least one physical verification XD may include a first physical verification 131, a second physical verification 132 to an N−1th physical verification 13X and an Nth physical verification 13N. Here, N may be a positive integer greater than 1. At least one physical verification XD may be performed by each verification tool. For example, verification input data may be input to the verification tool that performs at least one external physical verification XD, output verification results may be received, and output data may be generated.

In detail, the integrated circuit verification system may receive first data D1 and second data D2, for example from the user, in order to perform the integrated circuit verification method. The first data D1 and the second data D2 may be or may include or be included in data including information on an integrated circuit to be verified. As an example, the first data D1 may include intellectual property (IP) data of the integrated circuit, and the second data D2 may include place and route PnR data of the integrated circuit. The IP data of the integrated circuit may include data about elements and/or modules constituting or included the integrated circuit, such as but not limited to standard cell data. The PnR data of the integrated circuit may include data regarding positions and/or connections of components in the integrated circuit. According to various example embodiments, although the input data is divided into two types of data, the first data D1 and the second data D2, it is not limited to only two types of data, and the input data may mean at least one piece of data reflecting information of an integrated circuit. For example, because the information of the integrated circuit is divided into three types of data, the integrated circuit verification system may perform an integrated circuit verification method by receiving the three types of data. Alternatively or additionally, the integrated circuit verification system may indirectly receive the first data D1 and/or the second data D2 by receiving the storage locations of the first data D1 and/or the second data D2.

The integrated circuit verification system may generate chip data D3 by receiving the first data D1 and the second data D2 and performing data merging 110. The chip data D3 may include data representing an integrated circuit that is a target of an integrated circuit verification method. For example, the integrated circuit verification system may generate the chip data D3 by merging the IP data and the PnR data. The chip data D3 may be finally generated by designating the positional relationship and connection relationship of elements and components of the IP data through PnR data. The integrated circuit verification system may perform data merging 110 of the first data D1 and the second data D2 in the background. For example, the data merging 110 may be performed in the background, and the merging process may not be displayed to the user. Because the data merging 110 is executed in the background, unnecessary information leakage to the user may be prevented or reduced in likelihood of occurrence.

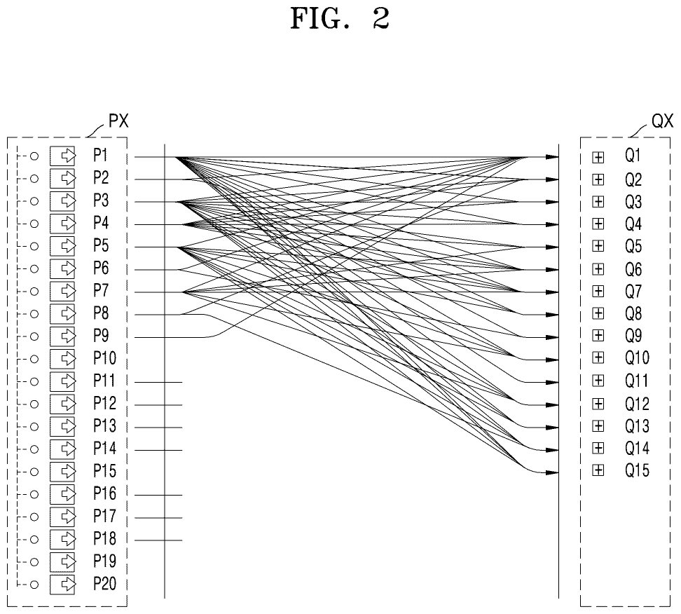

The integrated circuit verification system may perform verification input data extraction 120 based on the chip data D3. The verification input data may include data that is input to at least one physical verification XD. The verification input data may include the first verification input data DV1, the second verification input data DV2, through the N−1th verification input data DVX through the Nth verification input data DVN. The integrated circuit verification system may utilize an internal variable D4 in the process of extracting the verification input data based on the chip data D3. For example, through the verification input data extraction 120, the chip data D3 and the internal variable D4 may be allocated as the verification input data. The internal variable may be a variable necessary or used for performing at least one physical verification XD. For example, internal variables may include environment settings or input information required for input of an external program that performs physical verification. The integrated circuit verification system may allocate internal variables in consideration of the verification input data required for physical verification to be performed. As an example, the integrated circuit verification system may store an internal variable list for each verification tool. Referring to the stored list of internal variables for each verification tool, the integrated circuit verification system may assign internal variables as inputs for each physical verification. The internal variables may be assigned as the verification input data through an assignment process. A process of assigning internal variables is described below in detail with reference to FIG. 2.

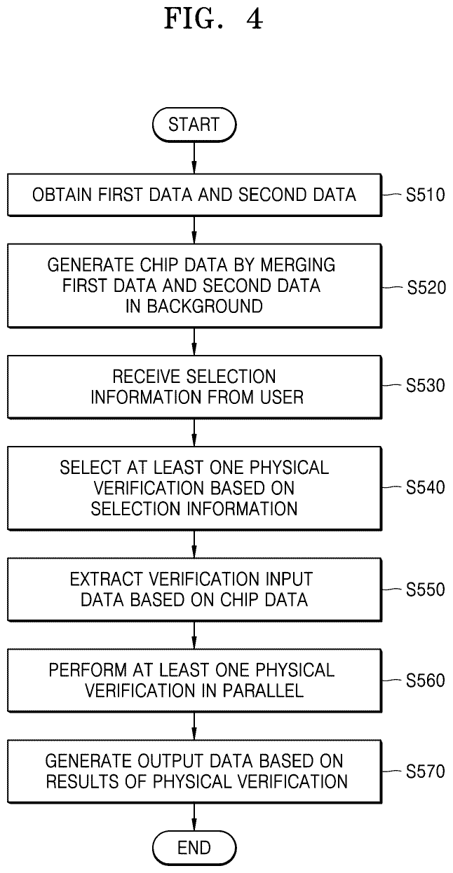

The verification input data may be input to an external physical verification tool so as to perform physical verification. The physical verification tool may perform physical verification based on the input verification input data, output verification results, and transfer them to the integrated circuit verification system. The first verification input data DV1 may be input to an external first physical verification tool to perform the first physical verification 131. The first physical verification tool may perform the first physical verification 131 and generate a first verification result DO1 that is the verification result. The integrated circuit verification system may receive the first verification result DO1 from the first physical verification tool. The second verification input data DV2 may be input to an external second physical verification tool to perform the second physical verification 132. The second physical verification tool may perform the second physical verification 132 and generate a second verification result DO2 that is the verification result. The integrated circuit verification system may receive the second verification result DO2 from the second physical verification tool. The N−1 th verification input data DVX may be input to an external N−1 th physical verification tool to perform the N−1 th physical verification 13X. The N−1 th physical verification tool may perform the N−1 th physical verification 13X and generate an N−1 th verification result DOX that is the verification result. The integrated circuit verification system may receive the N−1 th verification result DOX from the N−1 th physical verification tool. The Nth verification input data DVN may be input to an external Nth physical verification tool to perform the Nth physical verification 13N. The Nth physical verification tool may perform the Nth physical verification 13N and generate an Nth verification result DON that is the verification result. The integrated circuit verification system may receive an Nth verification result DON from the Nth physical verification tool. The integrated circuit verification system may additionally receive selection information from the user to select a physical verification to perform. The optional function of physical verification is described in detail below with reference to FIG. 4.

The integrated circuit verification system may generate 140 output data DO based on the verification results. The verification result may include a first verification result D01, a second verification result DO2, an N−1th verification result D0X, and an Nth verification result DON. The integrated circuit verification system may generate output data DO by aggregating verification results. The integrated circuit verification system may provide information through the output data DO, for example, so that the user may know or be informed of the result of at least one physical verification XD at once. In addition, the integrated circuit verification system may perform a process of displaying the progress of physical verification performed in parallel. The progress of physical verification may be displayed to the user to provide the progress of verification, which may improve convenience of use.

According to various example embodiments, the integrated circuit verification system may derive results of several physical verifications at once. Alternatively or additionally, the integrated circuit verification system redistributes input data and allocates input information necessary for or used for each physical verification to each physical verification, thereby greatly improving work efficiency and speed. Alternatively or additionally, the integrated circuit verification system may perform physical verification by merging data in the background and directly exchanging data with an external physical verification frame, thereby reducing or minimizing unnecessary exposure of information to the outside, which may enhance security, for example of the intellectual property related to the design of the integrated circuit.

FIG. 2 is a conceptual diagram illustrating a method of identifying and allocating at least one internal variable required for physical verification according to various example embodiments.

Referring to FIG. 2, at least one internal variable PX of the integrated circuit verification system may be reallocated and assigned to perform at least one physical verification. The at least one internal variable PX may include, for example, the first to twentieth internal variables P1 to P20. The number of at least one internal variable PX is not limited to 20, and may consist of or include at least one internal variable. The internal variable may be a variable necessary for or used for performing at least one physical verification XD. For example, the internal variables may include environment settings and/or input information required for input of an external program that performs physical verification. The internal variable may be internal data for generating at least one internal verification variable QX required for performing physical verification.

At least one internal variable PX may be assigned to at least one internal verification variable QX through an assignment process. For example, the at least one internal variable PX and the at least one internal variable QX may be related as a directed bipartite graph. The at least one internal verification variable QX may include the first to fifteenth internal verification variables Q1 to Q15. The at least one internal verification variable QX is not limited to 15, and may consist of or include at least one internal variable. The number of at least one internal verification variables QX may be greater than, less than, or equal to the number of at least one internal variables PX. At least one internal verification variable QX may be variables necessary to or used perform at least one physical verification XD. Because variables required or used for each type of physical verification or tool may be different, at least one internal variable PX assigned to each at least one internal verification variable QX may be different. At least one internal verification variable QX may be allocated corresponding the required physical verification, and at least one physical verification XD may be easily performed. At least one internal verification variable QX may be extracted as verification input data through a process of extracting verification input data 120 along with chip data D3.

According to various example embodiments, the integrated circuit verification system redistributes input data and allocates input information necessary or used for each physical verification to each physical verification, thereby greatly improving work efficiency and/or speed. Alternatively or additionally, the integrated circuit verification system may perform physical verification by merging data in the background and directly exchanging data with an external physical verification frame, thereby reducing or minimizing unnecessary exposure of information to the outside and enhancing security.

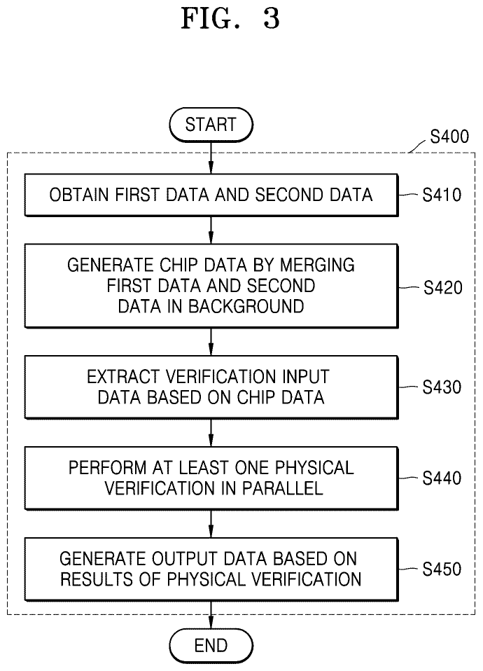

FIG. 3 is a flowchart illustrating a method of verifying, designing, and fabricating an integrated circuit, according to various example embodiments

As shown in FIG. 3, the integrated circuit verification, designing, and fabrication method may include a plurality of operations S410, S420, S430, S440 and S450. Hereinafter, FIG. 3 is described with reference to FIGS. 1 and 2.

In operation S410, the integrated circuit verification system may obtain first data D1 and second data D2. As an example, the first data D1 may include IP data of the integrated circuit, and the second data D2 may include PnR data of the integrated circuit. Descriptions already given about the first data D1 and the second data D2 are omitted.

In operation S420, the integrated circuit verification system may generate chip data D3 by merging the first data D1 and the second data D2 in the background. The chip data D3 may be data representing an integrated circuit that is a target of an integrated circuit verification method. For example, the integrated circuit verification system may generate chip data D3 by merging IP data and PnR data. The chip data D3 may be finally generated by designating the positional relationship and connection relationship of elements and components of the IP data through PnR data.

In operation S430, the integrated circuit verification system may extract verification input data based on the chip data D3. The verification input data may include data input to at least one physical verification XD. The verification input data may include first verification input data DV1, second verification input data DV2, N−1th verification input data DVX, and Nth verification input data DVN. The integrated circuit verification system may utilize an internal variable D4 in the process of extracting verification input data based on the chip data D3. The internal variables may be assigned as verification input data through an assignment process.

In operation S440, the integrated circuit verification system may perform at least one or more than one physical verification XD in parallel. The at least one physical verification XD may include a first physical verification 131, a second physical verification 132, an N−1th physical verification 13X, and an Nth physical verification 13N. Each of the at least one physical verification XD may be or may correspond to a verification tool that exists externally and may be performed externally. For example, the integrated circuit verification system may input verification input data to at least one external physical verification XD, receive output verification results, and generate output data.

In operation S450, the integrated circuit verification system may generate output data DO based on the results of the physical verification. The verification result may include a first verification result D01, a second verification result DO2, an N−1th verification result D0X, and an Nth verification result DON. The integrated circuit verification system may generate output data DO by aggregating verification results. The integrated circuit verification system may provide information through the output data DO so that the user may know the result of at least one physical verification XD at once.

Additionally, the integrated circuit may be designed. For example, the integrated circuit may be redesigned based on the output data generated in operation S450. For example, depending on the output data, one or more of layout or schematic may be redesigned, e.g., in the event that the verification indicates defects such as but not limited to design rule errors and/or design for manufacturability errors and/or layout-versus-schematic errors and/or other issues. In some example embodiments, the integrated circuit verification operations S400 and the integrated circuit design operation may be iteratively applied, for example, until the integrated circuit verification indicates no error. In some example embodiments, the time-to-verified-design may be reduced.

Additionally, an integrated circuit may be fabricated based on the integrated circuit design. For example, one or more photomasks may be manufactured or taped out or sent to a photomask house, based on the integrated circuit design. In some example embodiments, the one or more photomasks may be used, e.g., in a foundry, to fabricate the integrated circuit. In some example embodiments, the time-to-fabrication may be reduced.

According to various example embodiments, the integrated circuit verification system may derive results of several physical verifications at once. Alternatively or additionally, the integrated circuit verification system redistributes input data and allocates input information necessary for each physical verification to each physical verification, thereby greatly improving work efficiency and speed. Alternatively or additionally, the integrated circuit verification system may perform physical verification by merging data in the background and directly exchanging data with an external physical verification frame, thereby reducing or minimizing unnecessary exposure of information to the outside and enhancing security.

FIG. 4 is a flowchart illustrating a method of verifying an integrated circuit including a selection function, according to various example embodiments.

As shown in FIG. 4, the integrated circuit verification method may include a plurality of operations S510, S520, S530, S540, S550, S560, and S570. Hereinafter, FIG. 4 is described with reference to FIGS. 1 and 2.

In operation S510, the integrated circuit verification system may obtain first data D1 and second data D2. In operation S520, the integrated circuit verification system may generate chip data D3 by merging the first data D1 and the second data D2 in the background. In operation S550, the integrated circuit verification system may extract verification input data based on the chip data D3. In operation S560, the integrated circuit verification system may perform at least one physical verification XD in parallel. In operation S570, the integrated circuit verification system may generate output data DO based on the results of the physical verification. Operation S510 may be an example of operation S410. Operation S520 may be an example of operation S420. Operation S550 may be or correspond to an example of operation S430. Operation S560 may be an example of operation S440. Operation S570 may be an example of operation S450. Descriptions already given with reference to FIG. 3 regarding operations S510, S520, S550, S560, and S570 are omitted.

In operation S530, the integrated circuit verification system may receive selection information, e.g., from a user. Physical verification required for each user may be different. The selection information may include at least one physical verification that the user wants to select and requires verification. The selection information may be derived by selecting all available physical verifications, or may not select all physical verifications. Because verification tools may be different even within the same physical verification, the user may select at least one physical verification and tool. The selection information may be the same, or at least one may be different for each user and may be transmitted to an integrated circuit verification system.

In operation S540, the integrated circuit verification system may select at least one physical verification based on the selection information. The selection information may include information about at least one physical verification requested by the user. Therefore, in operation S540, the integrated circuit verification system may select at least one physical verification to perform verification based on the selection information. Internal variables and chip data may be converted into verification input data and input based on at least one selected physical verification. For the selected physical verification, verification input data may be input to at least one external physical verification XD, output verification results may be received, and output data may be generated.

According to various example embodiments, the integrated circuit verification system may provide a verification result by selecting at least one physical verification requested by a user. Alternatively or additionally, the integrated circuit verification system may provide more efficient and faster verification results by not performing physical verification not requested by the user.

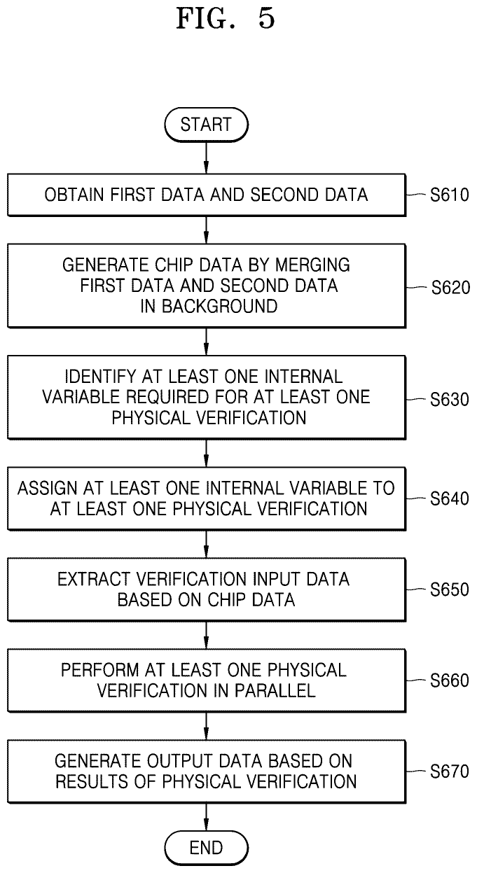

FIG. 5 is a flowchart illustrating a method of verifying an integrated circuit, including a process of identifying and allocating internal variables, according to various example embodiments.

As shown in FIG. 5, the integrated circuit verification method may include a plurality of operations S610, S620, S630, S640, S650, S660, and S670. Hereinafter, FIG. 5 is described with reference to FIGS. 1 and 2.

In operation S610, the integrated circuit verification system may obtain first data D1 and second data D2. In operation S620, the integrated circuit verification system may generate chip data D3 by merging the first data D1 and the second data D2 in the background. In operation S630, the integrated circuit verification system may extract verification input data based on the chip data D3. In operation S660, the integrated circuit verification system may perform at least one physical verification XD in parallel. In operation S670, the integrated circuit verification system may generate output data DO based on the results of the physical verification. Operation S610 may be an example of operation S410. Operation S620 may be an example of operation S420. Operation S650 may be an example of operation S430. Operation S660 may be an example of operation S440. Operation S670 may be an example of operation S450. Descriptions already given with reference to FIG. 3 regarding operations S610, S620, S650, S660, and S670 are omitted.

In operation S630, the integrated circuit verification system may identify at least one internal variable PX required for at least one physical verification XD. The variable may be internal data for generating at least one internal verification variable QX required to perform physical verification. For example, the internal variables may include environment settings or input information required for input of an external program that performs physical verification. Because variables required for or used for each type of physical verification or tool may be different, at least one internal variable PX assigned to each at least one internal verification variable QX may be different. As an example, the integrated circuit verification system may store an internal variable list for each verification tool. Referring to the stored list of internal variables for each verification tool, the integrated circuit verification system may assign internal variables as inputs for each physical verification. Descriptions already given with reference to FIG. 3 regarding internal variables are omitted.

In operation S640, the integrated circuit verification system may assign at least one internal variable PX to at least one physical verification XD. At least one internal verification variable QX may be allocated based on the required physical verification, and at least one physical verification XD may be easily performed. At least one internal verification variable QX may be extracted as verification input data through a process of extracting verification input data 120 along with chip data D3. Descriptions already given with reference to FIG. 3 in relation to internal variable assignment is omitted.

According to various example embodiments, the integrated circuit verification system redistributes input data and allocates input information necessary for each physical verification to each physical verification, thereby greatly improving work efficiency and/or speed, for example in a manner that is not practically performed in a human mind. Alternatively or additionally, the integrated circuit verification system may perform physical verification by merging data in the background and directly exchanging data with an external physical verification frame, thereby reducing or minimizing unnecessary exposure of information to the outside and enhancing security.

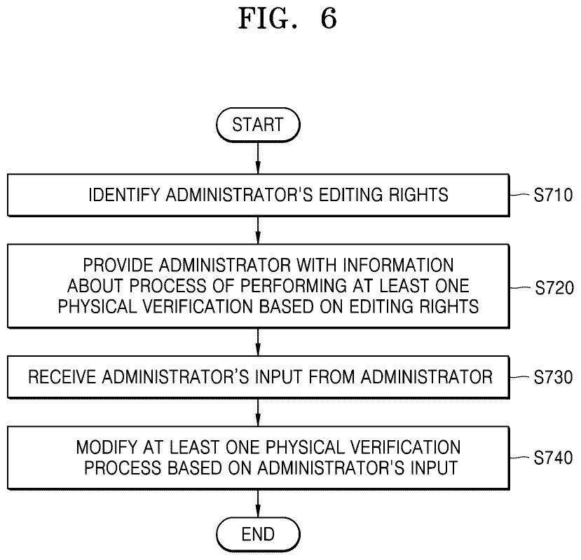

FIG. 6 is a flowchart illustrating a method of verifying an integrated circuit, including a function of correcting a verification process by identifying editing rights, according to various example embodiments

As shown in FIG. 6, the integrated circuit verification method may include a plurality of operations S710, S720, S730, and S740. Hereinafter, FIG. 6 is described with reference to FIGS. 1 and 2.

In operation S710, the integrated circuit verification system may identify an administrator's editing rights. The integrated circuit verification system may perform the integrated circuit verification method, so that the designed circuit may be supplemented or a producible circuit design may be made. Methods of circuit design or circuit processing may vary depending on technical issues, circumstances, and technological developments. Therefore, the integrated circuit verification system may require or use modification of the integrated circuit verification method depending on circumstances. When a change occurs in the development of an integrated circuit, the integrated circuit verification system may need to or should reflect the change in the integrated circuit verification method. To allow the integrated circuit verification method to be modified and edited by the administrator, the integrated circuit verification system may identify the administrator's editing rights.

In operation S720, the integrated circuit verification system may provide an administrator with information about a process of performing at least one physical verification XD based on editing rights. When the administrator's editing rights is identified, the integrated circuit verification system may transition to a management mode before performing a verification process. In the management mode, the integrated circuit verification system may provide the administrator with information about a process of performing at least one physical verification XD.

In operation S730, the integrated circuit verification system may receive administrator input from the administrator. An administrator may receive information about the provided process, determine an item to be corrected, and may transfer an administrator input to the integrated circuit verification system. The administrator input may include input information reflecting modifications of the integrated circuit verification method. As an example, the administrator input may include adding, deleting, or changing the process of performing physical verification. Alternatively or additionally, the administrator input may indicate a change that is updated to reflect a changed portion in the course of performing physical verification. In some example embodiments, an administrator may authorize one or more exceptions to, for example, the design rules, and may provide this exception as administrator input.

In operation S740, the integrated circuit verification system may modify at least one physical verification process based on the administrator input. The integrated circuit verification system may reflect modifications requested by the administrator based on the administrator input. As an example, upon receiving the addition, deletion and/or change of the physical verification process from the administrator input, the integrated circuit verification system may add, delete or change the physical verification.

The integrated circuit verification system may perform a plurality of operations S710, S720, S730, and S740 prior to operation S400 of FIG. 4. That is, the integrated circuit verification system may perform a process of reflecting changes prior to deriving physical verification.

According to various example embodiments, the integrated circuit verification system may modify and update the physical verification based on an administrator input, thereby providing an effect of continuously enabling efficient integrated circuit verification. Alternatively or additionally, when there is an error or improvement in the integrated circuit verification method, an effect that may be reflected based on the administrator input may be provided.

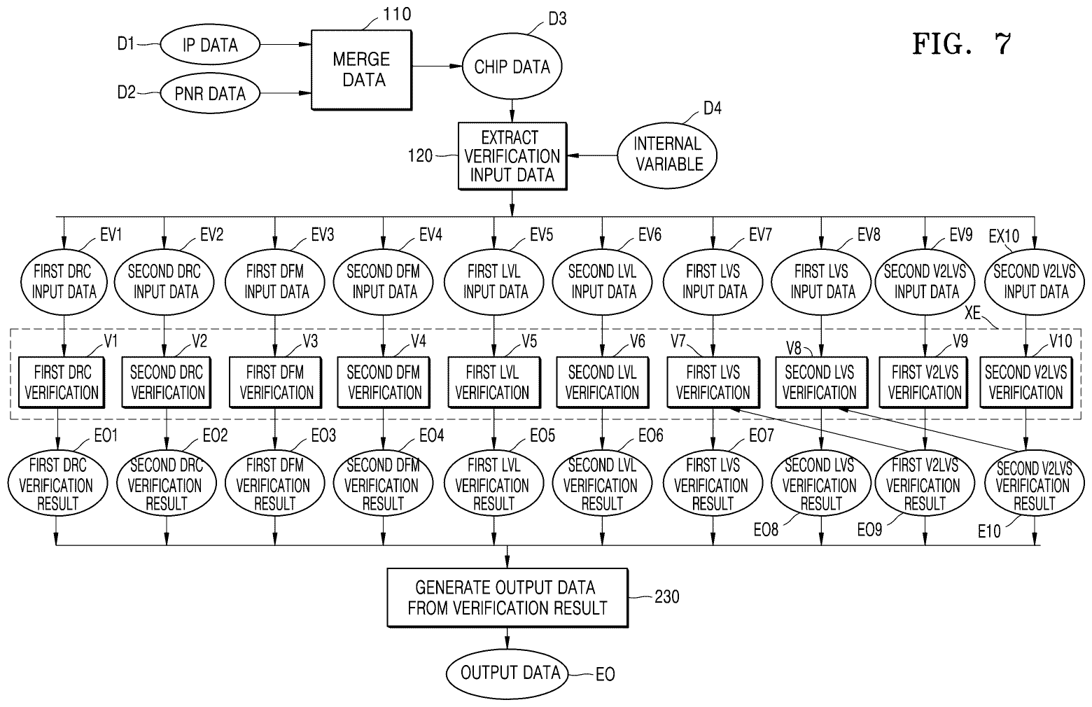

FIG. 7 is a block diagram illustrating a physical verification method of an integrated circuit, according to various example embodiments.

Referring to FIG. 7, the integrated circuit verification system may derive a result by performing at least one physical verification such as DRC, DFM, LVL, LVS, V2LVS, etc. in parallel. The method of physically verifying the integrated circuit of FIG. 7 may be an example of the method of verifying the integrated circuit of FIG. 1. Hereinafter, FIG. 7 is described with reference to FIGS. 1 and 2, and the description already given with reference to FIG. 1 is omitted.

The integrated circuit verification system may receive IP data E1 and PnR data E2 of the integrated circuit to be verified, and output output data EO based on verification results. The IP data E1 and the PnR data E2 may be examples of the first data D1 and the second data D2 of the integrated circuit.

An integrated circuit verification system according to various examples may perform at least one physical verification XE in parallel in a process of performing an integrated circuit verification method. The at least one physical verification XE may be an example of the at least one physical verification XD of FIG. 1. The at least one physical verification XE includes a first DRC verification V1, a second DRC verification V2, a first DFM verification V3, a second DFM verification V4, a first LVL verification V5, 2 LVL verification V6, a first LVS verification V7, a second LVS verification V8, a first V2LVS verification V9, and a second V2LVS verification V10. Descriptions already given with reference to FIG. 1 regarding DRC verification, DFM verification, LVL verification, LVS verification, and V2LVS verification are omitted. The first DRC verification V1 and the second DRC verification V2 may include verification tools that perform the same DRC verification and operate in different ways. The first DFM verification V3 and the second DFM verification V4 may include verification tools that perform the same DFM verification and operate in different ways. The first LVL verification V5 and the second LVL verification V6 may include verification tools that perform the same LVL verification and operate in different ways. The first LVS verification V7 and the second LVS verification V8 may include verification tools that perform the same LVS verification and operate in different ways. The first V2LVS verification V9 and the second V2LVS verification V10 may include verification tools that perform the same V2LVS verification and operate in different ways. As an example, through the integrated circuit verification system, a plurality of users may respectively check various physical verification results of the integrated circuit they have designed. Verification tools to be used may be different for each user who utilizes the integrated circuit verification system. The integrated circuit verification system may provide all verification results by verification tools that operate in different ways. In the integrated circuit verification method according to the example of FIG. 7, two verification tools are shown for the same physical verification, but the types of verification tools are not limited to only two. The verification tool of the integrated circuit verification method of the inventive concept is not limited to two, and may be given as one single tool or may mean a plurality of verification tools of three or more.

The integrated circuit verification system may generate chip data E3 by receiving the IP data E1 and the PnR data E2 and performing data merging 210. The data merging 210 and the chip data E3 may be an example of the data merging 110 and the chip data D3 of FIG. 1. The description already given with reference to FIG. 1 is omitted.

The integrated circuit verification system may perform verification input data extraction 220 based on the chip data E3. The integrated circuit verification system may utilize an internal variable E4 in the process of extracting verification input data based on the chip data E3. The verification input data may include data input to at least one physical verification XE. The verification input data may include first DRC input data EV1, second DRC input data EV2, first DFM input data EV3, second DFM input data EV4, first LVL input data EV5, second LVL input data EV6, first LVS input data EV7, second LVS input data EV8, first V2LVS input data EV9, and second V2LVS input data EV10. The verification input data extraction 220 may be or may include or be included in an example of the verification input data extraction 120 of FIG. 1.

The verification input data may be input to an external physical verification tool to perform physical verification. The physical verification tool may perform physical verification based on input verification input data, output verification results, and transfer the verification results to an integrated circuit verification system. The first DRC input data EV1 may be input to an external first DRC verification tool to perform the first DRC verification V1. The first DRC verification tool may perform the first DRC verification V1 and generate a first DRC verification result EO1 that is the verification result. The integrated circuit verification system may receive the first DRC verification result EO1 from the first DRC verification tool. The second DRC input data EV2 may be input to an external second DRC verification tool to perform the second DRC verification V2. The second DRC verification tool may perform the second DRC verification V2 and generate the verification result, the second DRC verification result EO2. The integrated circuit verification system may receive the second DRC verification result EO2 from the second DRC verification tool. The first DFM input data EV3 may be input to an external first DFM verification tool to perform the first DFM verification V3. The first DFM verification tool may perform the first DFM verification V3 and generate a first DFM verification result EO3 that is the verification result. The integrated circuit verification system may receive the first DFM verification result EO3 from the first DFM verification tool. The second DFM input data EV4 may be input to an external second DFM verification tool to perform the second DFM verification V4. The second DFM verification tool may perform the second DFM verification V4 and generate the verification result, the second DFM verification result EO4. The integrated circuit verification system may receive the second DFM verification result EO4 from the second DFM verification tool. The first LVL input data EV5 may be input to an external first LVL verification tool to perform the first LVL verification V5. The first LVL verification tool may perform the first LVL verification V5 and generate a first LVL verification result EO5 that is the verification result. The integrated circuit verification system may receive the first LVL verification result EO5 from the first LVL verification tool. The second LVL input data EV6 may be input to an external second LVL verification tool to perform the second LVL verification V6. The second LVL verification tool may perform the second LVL verification V6 and generate the verification result, a second LVL verification result EO6. The integrated circuit verification system may receive the second LVL verification result EO6 from the second LVL verification tool. The first LVS input data EV7 may be input to an external first LVS verification tool to perform the first LVS verification V7. The first LVS verification tool may perform the first LVS verification V7 and generate the verification result, a first LVS verification result EO7. The integrated circuit verification system may receive the first LVS verification result EO7 from the first LVS verification tool. The second LVS input data EV8 may be input to an external second LVS verification tool to perform the second LVS verification V8. The second LVS verification tool may perform the second LVS verification V8 and generate the verification result, a second LVS verification result EO8. The integrated circuit verification system may receive the second LVS verification result EO8 from the second LVS verification tool. The first V2LVS input data EV9 may be input to an external first V2LVS verification tool to perform the first V2LVS verification V9. The first V2LVS verification tool may perform the first V2LVS verification V9 and generate the verification result, a first V2LVS verification result EO9. The integrated circuit verification system may receive the first V2LVS verification result EO9 from the first V2LVS verification tool. The second V2LVS input data EV10 may be input to an external second V2LVS verification tool to perform the second V2LVS verification V10. The second V2LVS verification tool may perform the second V2LVS verification V10 and generate the verification result, a second V2LVS verification result EO10. The integrated circuit verification system may receive the second V2LVS verification result EO10 from the second V2LVS verification tool. A hardware description language such as but not limited to Verilog may be converted to a corresponding circuit diagram through V2LVS verification, and the circuit diagram corresponding to Verilog, which is an output of V2LVS, may be additionally input to LVS verification. The first V2LVS verification result EO9 may be additionally input to an external first LVS verification tool to perform the first LVS verification V7. In addition, the second V2LVS verification result EO10 may be additionally input to an external second LVS verification tool to perform the second LVS verification V8. The integrated circuit verification system may additionally receive selection information from the user to select a physical verification to perform. The description already given with reference to FIG. 4 regarding the optional function of physical verification is omitted.

The integrated circuit verification system may generate 230 output data E0 based on the verification results. The verification result may include a first DRC verification result E01, a second DRC verification result EO2, a first DFM verification result E03, and a second DFM verification result EO4, a first LVL verification result E05, a second LVL verification result EO6, a first LVS verification result E07, a second LVS verification result EO8, a first V2LVS verification result E09, and a second V2LVS verification result EO10. The description already given with reference to FIG. 1 is omitted.

According to various example embodiments, the integrated circuit verification system redistributes input data and allocates input information necessary for each physical verification to each physical verification, thereby greatly improving work efficiency and speed. Alternatively or additionally, the integrated circuit verification system may perform physical verification by merging data in the background and directly exchanging data with an external physical verification frame, thereby minimizing unnecessary exposure of information to the outside and enhancing security.

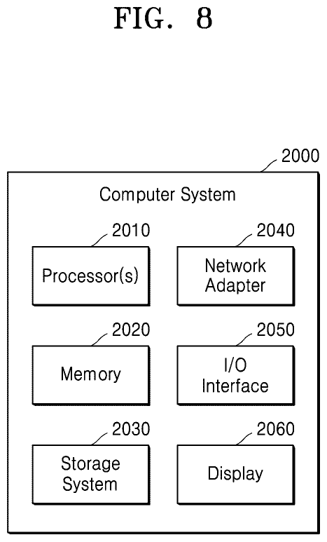

FIG. 8 is a block diagram illustrating a computer system according to an embodiment.

FIG. 8 is a block diagram illustrating a computer system 2000 according to an embodiment. In some example embodiments, the computer system 2000 of FIG. 8 may 8 may perform the integrated circuit verification method described above with reference to the drawings, and may be referred to as an integrated circuit verification system or an integrated circuit verification system or the like.

The computer system 2000 may refer to any system including a general purpose and/or special purpose computing system. For example, the computer system 2000 may include one or more of personal computers, server computers, laptop computers, consumer electronics, and the like. As shown in FIG. 8, the computer system 2000 may include at least one processor 2010, a memory 2020, a storage system 2030, a network adapter 2040, an input/output interface 2050, and a display 2060.

At least one processor 2010 may execute a program module including computer system executable instructions. The program module may include routines, programs, objects, components, logic, data structures, etc. that perform particular tasks or implement particular abstract data types. The memory 2020 may include computer system readable media in the form of volatile memory, such as random access memory (RAM). At least one processor 2010 may access memory 2020 and execute instructions loaded into memory 2020. The storage system 2030 may store information non-volatilely, and may include at least one program product including a program module configured to verify the integrated circuit described above with reference to the drawings in some embodiments. The program may include, as non-limiting example, an operating system, at least one application, other program modules, and program data.

The network adapter 2040 may provide connectivity to one or more of a local area network (LAN), a wide area network (WAN), and/or a public network (e.g., the Internet), and the like. The input/output interface 2050 may provide a communication channel with peripheral devices such as one or more of a keyboard, a pointing device, and an audio system. The display 2060 may output various information so that the user may check it.

In some example embodiments, the integrated circuit verification system described above with reference to the drawings may be implemented as a computer program product. The computer program product may include a non-transitory computer readable medium (or storage medium) including computer readable program instructions for causing at least one processor 2010 to perform image processing and/or training of models. The computer readable instructions may be, as non-limiting examples, source code or object code written in assembler instructions, instruction set architecture (ISA) instructions, machine instructions, machine dependent instructions, microcode, firmware instructions, state setting data, or at least one programming language.

The computer readable medium may be or may include or be included in any tangible medium capable of non-temporarily holding and storing instructions executed by at least one processor 2010 or any instruction executable device. The computer readable medium may be, but is not limited to, an electronic storage device, a magnetic storage device, an optical storage device, an electromagnetic storage device, a semiconductor storage device, or any combination thereof. For example, the computer readable medium may be, may include, or may be included in computer diskette, hard disk, random access memory (RAM), read-only memory (ROM), electrically erasable read only memory (EEPROM), flash memory, static random access memory (SRAM), CD, DVD, memory stick, floppy disk, a mechanically encoded device such as a portable punch card, or any combination thereof.

Any or all of the elements described with reference to FIG. 8 may communicate with any or all other elements described with reference to FIG. 8. For example, any element may engage in one-way and/or two-way and/or broadcast communication with any or all other elements in FIG. 1, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

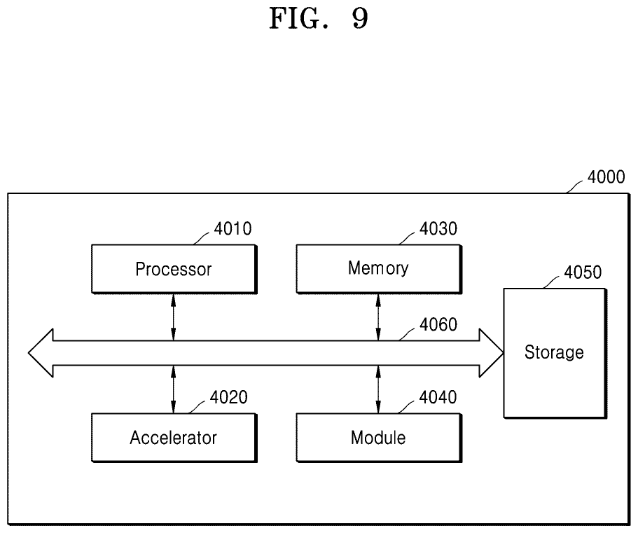

FIG. 9 is a block diagram illustrating a system according to an embodiment.

In some example embodiments, an integrated circuit verification method according to various example embodiments may be executed in a system 4000.

Referring to FIG. 9, the system 4000 may include at least one processor 4010, an accelerator 4020, a memory 4030, a module 4040, a storage 4050, and a bus 4060. Although only one processor 4010 is shown in FIG. 9, more processors may be provided. The processor 4010, memory 4030, module 4040, and storage 4050 may communicate with each other through a bus 4060 such as a wired bus and/or a wireless buss. In some example embodiments, at least one processor 4010, memory 4030, accelerator 4020, and module 4040 may be included in one semiconductor chip. Alternatively or additionally, in some example embodiments, at least two of the at least one processor 4010, memory 4030, accelerator 4020, and module 4040 may be respectively included in two or more semiconductor chips mounted on a board.

At least one processor 4010 may execute a series of instructions. For example, at least one processor 4010 may execute instructions stored in the memory 4030 or the storage 4050. In addition, at least one processor 4010 may load instructions from the memory 4030 or the storage 4050 into internal memory and execute the loaded instructions. The at least one processor 4010 may verify the integrated circuit by executing instructions stored in the memory 4030. In some example embodiments, the at least one processor 4010 may perform at least some of the operations described above with reference to FIGS. 1 to 8 by executing instructions.

For example, the at least one processor 4010 may execute an operating system by executing instructions stored in the memory 4030 or may execute applications executed on the operating system. In some example embodiments, by executing instructions, the at least one processor 4010 may instruct the accelerator 4020 and/or module 4040 to perform tasks, and may obtain a result of the task from the accelerator 4020 and/or the module 4040. In some example embodiments, the at least one processor 4010 may be an application specific instruction set processor (ASIP) customized for a specific purpose, and may support a dedicated instruction set.

Accelerator 4020 may be designed to perform predefined operations at high speeds. The accelerator 4020 may load data stored in the memory 4030 and/or the storage 4050, and store data generated by processing the loaded data in the memory 4030 and the storage 4050. In some example embodiments, the accelerator 4020 may perform at least some of the operations described above with reference to the drawings at high speed.

The memory 4030 is a non-transitory storage device and may be accessed through the bus 4060 by at least one processor 4010. In some example embodiments, the memory 4030 may include one or more of volatile memory, such as dynamic random access memory (DRAM) and/or static random access memory (SRAM) and the like, and may include non-volatile memory, such as flash memory and/or resistive random access memory (RRAM), and the like. In some example embodiments, the memory 4030 may store instructions and data for performing at least some of the operations described above with reference to the drawings.

The term ‘module’ used below refers to software or hardware components, such as field programmable gate array (FPGA) or application specific integrated circuit (ASIC), and the ‘module’ performs certain roles. However, the ‘module’ is not limited to software or hardware. The ‘module’ may be configured to reside on an addressable storage medium and may be configured to reproduce one or more processors. Accordingly, as an example, the ‘module’ may include components, such as software components, object-oriented software components, class components, and task components, and may include processes, functions, attributes, procedures, subroutines, segments of program code, drivers, firmware, microcode, circuits, data, databases, data structures, tables, arrays, and variables. Function provided within components and ‘modules’ may be combined into less numbers of components and ‘modules’ or further separated into additional components and ‘modules’.

The module 4040 may receive instructions from at least one processor 4010 and perform operations constituting or included in a method of detecting a hidden camera. The module 4040 may perform a method of verifying an integrated circuit using at least one processor 4010. Data necessary for performing the method may be stored in the storage 4050.

The storage 4050 is a non-temporary storage device, and stored data may not be lost even if power supply is cut off. For example, the storage 4050 may include a semiconductor memory device, such as a flash memory, or may include any storage medium, such as a magnetic disk or an optical disk. In some example embodiments, the storage 4050 may store instructions, programs, and/or data for performing at least some of the operations described above with reference to the drawings.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While various inventive concepts have been particularly shown and described with reference to various example embodiments thereof, it will be understood that various changes in form and details may be made therein without departing from the spirit and scope of the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. A method of verifying an integrated circuit, the method comprising:
obtaining first data defining elements in the integrated circuit, and second data defining positions and connection relationships of the elements;
generating chip data by merging the first data and the second data in background;
performing a plurality of physical verifications in parallel; and
generating output data, based on results of at least one of the physical verifications,
wherein the performing of the plurality of physical verifications in parallel includes,
extracting verification input data used for physical verification, based on the chip data.

2. The method of claim 1, wherein each of the at least one of the physical verifications is based on at least one of design rule check (DRC), design for manufacturability (DFM), layout versus layout (LVL), layout versus schematic (LVS), and Verilog to LVS (V2LVS).

3. The method of claim 1,
wherein at least one of the physical verification includes LVS verification and V2LVS verification, and
a verification input data of the LVS verification includes a verification result of the V2LVS verification.

4. The method of claim 1, further comprising:
receiving selection information; and
selecting the at least one physical verification, based on the selection information.

5. The method of claim 1, further comprising:
identifying at least one internal variable used for the at least one physical verification; and
assigning the at least one internal variable to the at least one physical verification.

6. The method of claim 1, further comprising:
identifying editing rights;
providing information about a process of execution of the at least one physical verification, based on the editing rights;
receiving an administrator input; and
modifying the execution process, based on the administrator input.

7. The method of claim 1, further comprising:
displaying a progress status of the physical verifications performed in parallel.

8. A system for verifying an integrated circuit, the system comprising:
at least one processor; and
a non-transitory storage medium storing instructions which, when executed by the at least one processor, cause the system to execute a process of verifying the integrated circuit,
wherein the at least one processor is configured to obtain first data defining elements in the integrated circuit, and second data defining positions and connection relationships of the elements,
generate chip data by merging the first data and the second data in background,
perform at least one physical verification in parallel, and
generate output data, based on results of the at least one physical verification,
wherein the performing of at least one physical verification in parallel includes,
extracting verification input data used for physical verification from the chip data.

9. The system of claim 8, wherein each of the at least one physical verification is based on at least one of design rule check (DRC), design for manufacturability (DFM), layout versus layout (LVL), layout versus schematic (LVS), and Verilog to LVS (V2LVS).

10. The system of claim 8,
wherein the at least one physical verification includes LVS verification and V2LVS verification, and
verification input data of the LVS verification includes a verification result of the V2LVS verification.

11. The system of claim 8, wherein the at least one processor is configured to
receive selection information, and
select the at least one physical verification, based on the selection information.

12. The system of claim 8, wherein the at least one processor is configured to
identify at least one internal variable used for the at least one physical verification, and
assign the at least one internal variable to the at least one physical verification.

13. The system of claim 8, wherein the at least one processor is configured to
identify editing rights,
provide information about a process of executing the at least one physical verification, based on the editing rights,
receive an administrator input, and
modify the execution process, based on the administrator input.

14. The system of claim 8, wherein the at least one processor is configured to execute instructions to display on a screen a progress status of the at least one physical verification performed in parallel.

15. A non-transitory storage medium for storing instructions which, when executed by at least one processor, cause the at least one processor to execute a process of verifying an integrated circuit,
wherein the process of verifying the integrated circuit comprises,
obtaining first data defining elements in the integrated circuit, and second data defining positions and connection relationships of the elements;
generating chip data by merging the first data and the second data in background;
performing at least one physical verification in parallel; and
generating output data, based on results of the at least one physical verification,
wherein the performing of at least one physical verification in parallel comprises
extracting verification input data used for physical verification from the chip data.

16. The non-transitory storage medium of claim 15, wherein each of the at least one physical verification is based on at least one of design rule check (DRC), design for manufacturability (DFM), layout versus layout (LVL), layout versus schematic (LVS), and Verilog to LVS (V2LVS).

17. The non-transitory storage medium of claim 15,
wherein the at least one physical verification includes LVS verification and V2LVS verification, and
verification input data of the LVS verification includes a verification result of the V2LVS verification.

18. The non-transitory storage medium of claim 15, further comprising:
instructions to select information; and
instructions to select the at least one physical verification, based on the selection information.

19. The non-transitory storage medium of claim 15, further comprising:
instructions to identify at least one internal variable used for the at least one physical verification; and
instructions to assign the at least one internal variable to the at least one physical verification.

20. The non-transitory storage medium of claim 15, further comprising:
instructions to identify editing rights;
instructions to provide information about a process of executing the at least one physical verification, based on the editing rights;
instructions to receive an administrator input; and
instructions to modify the execution process, based on the administrator input.
